(19) United States
(12) Patent Application Publication
(10) Pub. No.: US 2008/0071700 A1
(43) Pub. Date: Mar. 20, 2008

(54) Securities Index and Fund With Probability Threshold Criteria

(76) Inventor: Michael Luke Catalano-Johnson, Malvern, PA (US)

Correspondence Address: FISH & RICHARDSON P.C., P.O. BOX 1022, MINNEAPOLIS, MN, 55440-1022, US

(21) Appl. No.: 11/533,308

(22) Filed: Sep. 19, 2006

(51) Int. Cl. G06Q 40/00

(52) U.S. Cl. 705/36 R

(57) ABSTRACT

A probabilistic threshold index or fund method of determining membership of financial instruments in an index or fund comprises determining measurement values for a list of companies, determining constraints based on these measurement values, specifying a probability model, and reconstituting the index or fund based on the model probability that the measurement values of these financial instruments will satisfy the constraints at a time in the future. The method can be used with fixed probability thresholds, deleting financial instruments with probabilities lower than the lower threshold, and adding non-member financial instruments with probabilities higher than the upper threshold. The method may be adapted to maintain an index or fund with a fixed number of financial instruments. A fund or index may be constituted according to the index or fund, and a marketplace may comprise one or more funds or indices.

### TECHNICAL FIELD

The invention relates to financial instruments, and more particularly to determining membership of financial instruments in an index and/or fund.

### BACKGROUND

As used herein, the term “financial instruments” includes securities, commodities and any other financial instruments created, developed or otherwise derived from an index or fund, including without limitation, exchange traded funds, options (including, but not limited to, options on any index or fund), futures, and swaps.

Some index or fund creation or maintenance methodologies prescribe the addition and/or deletion of financial instruments from an index or fund when a characteristic (or characteristics) or a financial instruments achieves or fails to meet a predefined criterion (or criteria, in the case of multiple characteristics). For example, at its annual reconstitution, membership in the Russell 2000 index is defined as the stocks of those United States domiciled companies whose rank by market capitalization is greater than or equal to 1001 and less than or equal to 3000. Other methodologies permit the continued inclusion of financial instruments in an index or fund which do not meet initial criterion provided that they still meet a slightly less stringent criterion; financial instruments meeting only this less stringent criterion are often referred to as being in the “buffer zone.” These buffer zones also are typically defined in terms of particular cutoff values for the characteristic (e.g., market capitalization rank) being measured.

Events in which one or more financial instruments are added or deleted from an index or fund are referred to as “rebalances.” In a rebalance, financial instruments that were added or deleted in a previous rebalance often times are deleted or added, respectively. This is a situation which may happen repeatedly. In attempting to focus specifically on financial instruments with a particular range of values for one or more selected characteristics (e.g., market capitalization), those tracking the index or fund may suffer tax consequences, excessive trading costs or other negative events from the in-again, out-again behavior of some financial instruments on the borderline of the fixed range.

### SUMMARY

In one aspect of the invention, a probabilistic threshold method is provided for determining continuing inclusion or exclusion of a financial instrument from an index or fund. The model includes fixing a time horizon tₕ and a probability Hₜ_{ₕ} that company i will meet the criteria at time tₕ in the future. The method includes the selection of threshold probabilities 0≦p_{L}≦p_{U}≦1. Rebalancing the index or fund by this method then deletes or removes the i^{th} financial instrument if it is currently in the index or fund and Hₜ_{ₕ}(i)<p_{L}, adds the i^{th} financial instrument if it is currently not in the index or fund and Hₜ_{ₕ}(i)>p_{U}. The remaining financial instruments maintain their previous membership status. That is, if they were a member, then they stay a member, and if they were not a member then they stay not a member.

In another aspect of the invention, a probabilistic method for determining inclusion and exclusion of financial instruments from an index or fund is provided which maintains a fixed number of financial instruments (N) in the index or fund at all times. The method includes determining a set of characteristics for each company in a list of companies. Furthermore the method includes the choice of a subset of the characteristic values (the criteria, or rules) which determine the eligibility of the financial instrument for inclusion in the index or fund. The model includes the fixing of a time horizon tₕ and fixing a probability Hₜ_{ₕ}(i) that the company i will meet the criteria at a time tₕ in the future. Eligible companies are ranked from highest to lowest by their numerical probabilities Hₜ_{ₕ}(i) and those with the N highest values will constitute the new index or fund. Companies not currently in the index or fund which are not ranked among the N highest are added. Companies in the index or fund which are not ranked among the N highest are deleted.

In another aspect of the invention, a fund or index comprised of certain specified financial instruments may be constituted utilizing a method of the invention. Moreover, a marketplace may permit trading of one or more of such indices or funds constituted according to a method of the invention or the trading of any options on such indices or funds.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of a computer system.

FIG. 2 is a chart showing a set of weight adjustment functions.

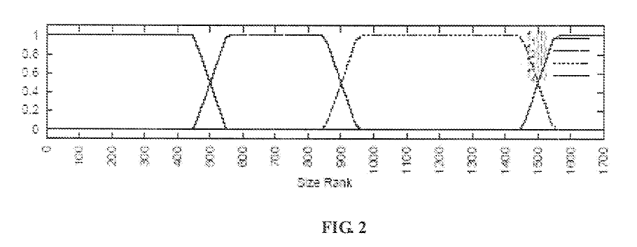

### DETAILED DESCRIPTION

As used herein, the terms “select” and “determine” include selecting, electing, choosing, determining, establishing, calculating, picking, obtaining, or any other similar action.

A probabilistic threshold index or fund methodology (PTIM) determines whether to add and/or delete financial instruments from an index or fund based on whether a probability of meeting those criteria at some point in the future is sufficiently large or small.

The method includes determining a set of characteristics for each company, commodity, or other financial instrument (including derivative instruments) in a list of companies, commodities, or financial instruments (including derivative instruments), respectively. These characteristics may include, but are not limited to, market capitalization, dividend payouts, company revenues, company book value, asset class or expiration date. These characteristics may be quantitative in nature, taking on a range of numerical values, like the previous examples cited, or they may be quantitative in nature. Non-limiting examples of the latter include the country of incorporation and the industrial classification of the company. Furthermore, the method includes the choice of a subset of the characteristic values (the criteria, or rules) which determine the eligibility of the financial instrument for inclusion in the index or fund. A non-limiting example would be the set of companies with market capitalization greater than one billion dollars and dividend yields exceeding two percent.

As a non-limiting example, suppose a measurement, such as market capitalization, of companies is available and an index or fund is intended to track a portfolio of financial instruments of these companies whose measurement value satisfies a set of constraints. As a further non-limiting example, one constraint may be that the market capitalization rank falls within a certain or specified range of values.

At a time of constitution, a time horizon tₕ is determined, which may be any time period desired. It is understood that as used herein, “constitution” may include the original creation of an index or fund, or may include any reconstitution, in which the composition of financial instruments in an index or fund may be adjusted, for example by adding and/or deleting financial instruments from the index or fund.

Time periods include, but are not limited to, periods of minutes, hours, days, months, or years. An upper threshold probability p_{U} and a lower threshold probability p_{L} are fixed so that 0≦p_{L}≦p_{U}≦1. A model H is given that assigns to a financial instrument Fᵢ hypothetically in index or fund a projected probability Hₜ_{ₕ}(i) that the financial instrument's measurement value or values will satisfy all of the constraints at time tₕ in the future.

In one exemplary embodiment of the invention, a financial instrument Fᵢ that is currently in the index or fund is deleted only if Hₜ_{ₕ}(i)<p_{L}. That is, only those financial instruments that have a sufficiently low model probability at time tₕ of meeting the constraints defining that index or fund are deleted. Likewise, a financial instrument Fᵢ that is not currently in the index or fund is added to the index or fund if Hₜ_{ₕ}(i)>p_{U}.

As an illustration of how such a methodology can reduce index or fund turnover, a non-limiting example involves an index or fund that intends to focus on the top 250 stocks on a given market or exchange, by market capitalization. Two index or fund member stocks, A and B, whose market capitalization ranking are 255 and 260, respectively, are considered. Under usual methodologies, with or without the use of buffer zones, Stock B is more likely to be deleted from the index or fund than stock A, since its market capitalization is lower.

The probability method can be flexible enough to incorporate information about the financial instrument that is not reflected in the single snapshot of market capitalization. For instance, it may incorporate the volatility (historical or implied) of the financial instruments in assigning the probabilities. It may be that stock A is issued by a company currently in an agreement to be acquired for cash several months in the future and whose volatility is very small, wile stock B is much more volatile. In this case, such a model may have Hₜ_{ₕ}(A)<Hₜ_{ₕ}(A), recognizing that stock A has a very small chance of meeting the market-cap constraints in the future, while stock B's chances are greater.

The PTIM model may for example be adapted to maintain an index or fund with a fixed number (N) of financial instruments. Financial instruments are ranked by their probability Hₜ_{ₕ}(i) that they will meet the index or fund constraints at time tₕ in the future. The period of time utilized may be any useful period of time, including, but not limited to, a week, month, quarter, or year. The N financial instruments with the highest probabilities are chosen for membership in the new index or fund. Financial instruments in the old index or fund but not in the new index or fund are deleted.

The PTIM methodology is capable of allowing a user to choose the probabilistic method specified in the function Hₜ_{ₕ}. Two non-limiting examples of models that are suitable for use in the PTIM methodology are found below.

In one exemplary embodiment, a historical covariance model takes advantage of the information in the price history of a set of financial instruments, the historical volatility of the financial instrument's returns themselves, and the relationships between the financial instrument's returns to calculate the probability inclusion function Hₜ_{ₕ}.

The covariance matrix Σ for the logarithmic-returns of the financial instruments is estimated for a point in time to time horizon tₕ for the universe of all eligible financial instruments. This estimation may be performed in any useful manner, including, but not limited to, through calculation of pair-wise covariances for all pairs of financial instruments using historical data, though various methods of reducing dimensionality such as, but notwithstanding, factor models, industrial sector based correlations, or through the use of forward looking option implied volatility data.

In this exemplary embodiment, Hₜ_{ₕ}(i) may be defined by a statistical modeling process such as a Monte-Carlo process. The Monte-Carlo method and other such methods are known to those skilled in the art. Utilizing the Monte-Carlo example, Hₜ_{ₕ}(i) is the proportion of Monte-Carlo trials in which financial instrument F meets the index or fund constraints at time tₕ.

In this example, a number of trials N_{T} may be fixed. In each trial, a joint normal distribution with covariance matrix Σ is drawn. Based on these financial instrument returns, the market capitalization ranking of the financial instruments at time tₕ is calculated. If the market capitalization rank of the financial instrument in the trial of the simulation meets the constraints, then in this Monte-Carlo trial the financial instrument would be included in the index or fund; otherwise it would not be included in the index or fund.

In a further exemplary embodiment, options market information may be used in a probability inclusion faction Hₜ_{ₕ}, for example an option implied risk neutral distribution model may be used. Such options market information may be used to take advantage of information that is contained in the options market to estimate the probability inclusion function Hₜ_{ₕ}.

Using market capitalization as an exemplary constraint, at the time of rebalance, the highest MC_{H} and the lowest MC_{L} market capitalization that a financial instrument may have and still meet the ideal constraints defining the index or fund are determined. As a non-limiting example, if an index or fund is to be defined as the set of companies whose market cap rank is between 251 and 500, then determine the market-capitalization of the 251st and 500th largest security.

Assume that options trade on all financial instruments, in a set of financial instruments expiring at time tₕ. Then the set of such options on the underlying financial instrument F implies a risk-neutral probability distribution p_{F} for the financial instrument at time tₕ. (If options traded are on a continuum or strikes, then the distribution may be defined, for example, as (∂²C)/(∂K²), where C=C(K), the value of the call C with strike K.) Next, define

$${H}_{{t}_{h}} ( F ) = {\int }_{{MC}_{H} / FO ( i )}^{{MC}_{H} / FO ( i )} {p}_{F} ( x ) d x$$

where OF(i) is the number of shares outstanding OF of financial instrument F.

The PTIM described herein is capable of reducing index or fund turnover, while permitting turnover more desirable for the index or fund to track its particular segment of the market. It also may express the addition/deletion criteria in probabilistic terms rather than in the institution of arbitrary cutoff values. In addition, it is flexible and can accommodate a variety of different probability models. Furthermore, the methodology is modified easily to meet other index or fund requirements, such as, but not limited to, maintaining a fixed number of financial instruments in the index or fund.

In a further embodiment of the invention, the method described above may be utilized to select financial instruments that may constitute all or part of one or more indexes or funds of financial instruments, including but not limited to, an exchange traded fund (ETF). It is understood that the term “fund” or “index,” as used herein, includes ETF's and the like, without limitation, as understood in the art. The method may, for example, be utilized to determine the initial constitution of a fund, and may also preferably be utilized to re-constitute or maintain the fund periodically.

As non-limiting examples, a fund based on a method of the invention may constitute exactly those financial instruments within an index or fund created or maintained according to the system or method. Alternatively, an index or fund created or maintained according to the invention may identify a subset of securities within a fund; or a fund may constitute a subset of the financial instruments of an index or fund created or maintained according to the invention; or a combination of both.

In a further embodiment, one or more funds, securities, futures or other financial instruments according to the invention may be traded on a marketplace for such financial instruments. It is understood that the term “marketplace” is construed broadly herein, to include (i) all U.S. and foreign exchanges, including without limitation, all organizations, associations or groups of persons, whether incorporated on unincorporated, that constitute, maintain or provide a marketplace or facilities for bringing together buyers and sellers of securities, futures and/or other financial instruments, for bringing together orders for securities, futures and/or other financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) all U.S. and foreign quotation and trade reporting systems or any other similar facilities or market centers where orders to buy and sell securities, futures, and/or other financial instruments interact with each other; (iii) all, and all market facilities maintained by any such, exchanges, quotation systems, trading centers, alternative trading systems, alternative display facilities, automated trading centers, electronic communications networks or other facilities; and (iv) all U.S. and foreign over-the-counter markets, including, without limitation, all in-person, telephone, computer or other electronic networks that connect buyers and sellers of securities, futures, and/or other financial instruments. A marketplace may constitute an exchange, quotation system, trading center, automatic trading system, electronic communications network or other marketplace on which one or more funds, securities, futures or other financial instruments according to the invention are traded.

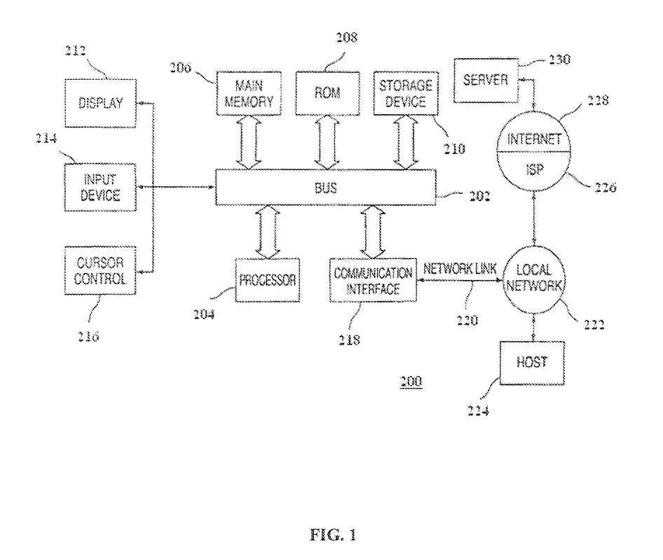

FIG. 1 illustrates an exemplary system, such as a computer system, on which the methodology described herein can be utilized. One suitable computer system upon which the method may be implemented is shown at 200. Computer system 200 includes a bus 202 or other communication mechanism for communication information, and a processor 204 coupled with bus 2302 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, which may include alphanumeric and other keys, is coupled to bus 202 for communicating information and command selections to processor 204. Another type of user input device is cursor control 216, such as a mouse, a trackball, or cursor directions keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

According to one embodiment, computer system 200 operates in response to processor 204 executing one or more sequences of one or more instructions contained in main memory 206. Such instructions may be read into main memory 206 from another computer-readable medium, such as storage device 210. Execution of the sequences of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement the methodology. Thus, practicing the methodology are not limited to any specific combination or hardware circuitry and software, and the description here and below is understood to be an exemplary embodiment of a system of the invention.

A software application containing coding for implementing the process described herein can be stored or reside in any suitable computer readable medium. The term “computer-readable medium” as used herein refers to any medium that participates in instructions to processor 204 for execution. Such a medium may take many forms, including, but not limited to non-volatile media, volatile media, and transmission media. Non-volatile media include, for example, optical or magnetic disks, such as storage device 210. Volatile media include dynamic memory, such as main memory 206. Transmission media include coaxial cables, copper wire, and fiber optics, including the wires that comprise bus 202. Transmission media can also take the form of acoustic or light waves, such as those generated during radio frequency (RF) and infrared (IR) data communications. Common forms of computer-readable media include, for example, floppy disk, a flexible disk, hard disk, magnetic tape, and other magnetic medium, a CD-ROM, DVD, any other optical medium, punch cards, paper type, any other physical medium with patters of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially by borne on a magnetic disk of a remote computer. The remote computer can load the instructions into its dynamic memory and send the instructions over a telephone line using a modem. A modem local to computer system 200 can receive the data on the telephone line and use an infrared transmitter to convert the data to an infrared signal. An infrared detector coupled to bus 202 can receive the data carried in the infrared signal and place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic, or optical signals that carry digital data streams representing various type of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the worldwide packet data communication network, now commonly referred to as the “Internet” 228. Local network 222 and Internet 228 both use electrical, electromagnetic, or optical signals that carry digital data streams. The signals through the various networks and the signals on network line 220 and through communication interface 218, which carry the digital data to and from computer system 200, are exemplary forms of carrier waves transporting the information.

Computer system 200 can send messages and receive data, including program codes, through the network(s) network line 220, and communication interface 218. In the Internet example, a server 230 might transmit a requested code for an application program through Internet 228, ISP 226, local network 222, and communication interface 218.

The received code may be executed by processor 204 as it is received, and/or stored in storage device 210, or other non-volatile storage later execution. In this manner, computer system 200 may obtain an application code in the form of a carrier wave.

A number of embodiments of the invention have been described. Nevertheless, it will be understood that various modifications may be made without departing from the spirit and scope of the invention. For example, although an example refers to stocks and companies, the methods described herein can be used for any type of financial instrument. Accordingly, other embodiments are within the scope of the following claims.

What is claimed is:

1. A probabilistic threshold index or fund method for determining membership in an index or fund i comprising:
determining at least one measurement value for a list of companies;
determining at least one constraint based on the measurement value;
constituting the index or fund by:
setting lower and upper threshold probabilities 0≦pₗ≦p_{U}≦1;
executing a model H that assigns to a financial instrument Fᵢ for a company in the list of companies a projected probability Hₜ_{ₕ}(i) that the measurement value will satisfy the constraint at time tₕ;
removing financial instrument Fᵢ if Hₜ_{ₕ}(i)<p_{L}, if Fᵢ is in the index or fund;
adding financial instrument Fᵢ if Hₜ_{ₕ}(i)>p_{U}, if Fᵢ is not in the index or fund.

2. The method of claim 1, wherein the measurement value comprises market capitalization.

3. The method of claim 2, wherein the constraint comprises having the market capitalization value fall within a range of values.

4. The method of claim 1, wherein the measurement value incorporates a financial instrument's volatility.

5. The method of claim 1, wherein the index or fund i maintains a fixed number of financial instruments.

6. The method of claim 1, wherein the financial instrument comprises stock.

7. The method of claim 1, wherein the list of companies comprise companies found in a second index or fund.

8. The method of claim 1, further comprising replacing a deleted or removed financial instrument with a financial instrument having a high value of Hₜ_{ₕ}(i), whereby Hₜ_{ₕ} refers to a probability inclusion function at time tₕ for financial instrument Fᵢ.

9. The method of claim 1, wherein the model H includes a Monte-Carlo process.

10. The method of claim 1, wherein the model H utilizes options market information.

11. The method of claim 1, further comprising trading the index or fund on a marketplace.

12. The method of claim 11, wherein the marketplace comprises at least one item selected from the group consisting of an exchange, a quotation and trade reporting system, a market facility, and an over-the-counter market.

13. The method of claim 11, wherein the marketplace comprises at least one item selected from the group consisting of an exchange, quotation system, trading center, alternative trading system, automatic trading system, and a electronic communications network.

14. A method for determining membership in an index or fund i, wherein the index or fund i maintains a number (N) of financial instruments, comprising:
determining at least one measurement value for a list of companies;
determining at least one constraint based on the measurement values;
constituting the index or fund i comprising:
creating a model H that assigns to a financial instrument Fᵢ in the list of companies a projected probability Hₜ_{ₕ}(i) that the measurement values will satisfy the constraint at time tₕ;
ranking companies by descending value of Hₜ_{ₕ}(i), deleting those financial instruments in the index or fund which rank below N and adding those in the index or fund that ranked at or above N in this ranking.

15. The method of claim 14, wherein the measurement value comprises market capitalization.

16. The method of claim 15, wherein the constraint comprises having the market capitalization value fall within a range of values.

17. The method of claim 14, wherein the measurement value incorporates a financial instrument's volatility.

18. The method of claim 14, wherein the financial instruments comprises stocks.

19. The method of claim 14, further comprising trading the index or fund on a marketplace.

20. The method of claim 19, wherein the marketplace comprises at least one item selected from the group consisting of an exchange, a quotation and trade reporting system, a market facility, and an over-the-counter market.

21. The method of claim 19, wherein the marketplace comprises at least one item selected from the group consisting of an exchange, quotation system, trading center, alternative trading system, automatic trading system, and an electronic communications network.

22. A fund comprising a plurality of financial instruments, wherein the plurality of financial instruments are selected by:
determining at least one measurement value for a list of companies;
determining at least one constraint based on the measurement value;
constituting an index or fund i by:
setting lower and upper threshold probabilities 0≦p_{L}≦p_{U}≦1;
executing a model H that assigns to a financial instrument Fᵢ for a company in the list of companies a projected probability Hₜ_{ₕ}(i) that the measurement value will satisfy the constraint at time tₕ;
removing financial instrument Fᵢ if Hₜ_{ₕ}(i)<p_{L}, if Fᵢ is in the index or fund;
adding financial instrument Fᵢ if Hₜ_{ₕ}(i)>p_{U}, if Fᵢ is not in the index or fund; and
assigning at least a portion of the financial instruments within the index or fund to the fund.

23. The fund according to claim 22, wherein all of the financial instruments within the index or fund are assigned to the fund.

24. The fund of claim 22, wherein the fund maintains a fixed number of financial instruments;

25. The fund of claim 22, wherein the financial instruments comprise stocks.

26. A financial instruments marketplace comprising at lease one fund or index, or options of the fund or index, the fund comprising a plurality of financial instruments, wherein the plurality of financial instruments are selected by:
determining at least one measurement value for a list of companies;
determining at least one constraint based on the measurement value;
constituting the index or fund by:
setting lower and upper threshold probabilities 0≦p_{L}≦p_{U}≦1;
executing a model H that assigns to a financial instrument Fᵢ for a company in the list of companies a projected probability Hₜ_{ₕ}(i) that the measurement value will satisfy the constraint at time tₕ;
removing financial instrument Fᵢ if Hₜ_{ₕ}(i)<p_{L}, if Fᵢ is in the index or fund;
adding financial instrument Fᵢ if Hₜ_{ₕ}(i)>p_{U}, if Fᵢ is not in the index or fund; and
assigning at lease a portion of the financial instruments within the index or fund to the fund.

27. The fund according to claim 26, wherein all of the financial instruments within the index or fund are assigned to the fund.

28. The method of claim, wherein the fund maintains a fixed number of financial instruments.

29. The method of claim 26, wherein the financial instruments are stocks.

30. The method of claim 26, wherein the marketplace comprises at least one item selected from the group consisting of an exchange, a quotation and trade reporting system, a market facility, and an over-the-counter market.

31. The method of claim 26, wherein the marketplace comprises at lease one item selected from the group consisting of an exchange, quotation system, trading center, alternative trading system, automatic trading system, and an electronic communications network.
